(19) United States
(12) Patent Application Publication
(10) Pub. No.: US 2018/0259125 A1
(43) Pub. Date: Sep. 13, 2018

(54) Pressure Vessel Comprising a Load Ring, Motor Vehicle, and Method for Manufacturing a Pressure Vessel

(71) Applicant: Bayerische Motoren Werke Aktiengesellschaft, Muenchen (DE)

(72) Inventors: Olivier COUSIGNE, Wielenbach-Haunshofen (DE); Timo CHRIST, Muenchen (DE)

(21) Appl. No.: 15/977,557

(22) Filed: May 11, 2018

Related U.S. Application Data
(63) Continuation of application No. PCT/EP2016/073877, filed on Oct. 6, 2016.

(30) Foreign Application Priority Data
Nov. 13, 2015 (DE) 10 2015 222 392.2

(51) Int. Cl. F17C 1/08; F17C 1/06; F17C 1/00

(52) U.S. Cl. CPC F17C 1/08; F17C 1/06; F17C 1/005; F17C 2201/0109; F17C 2209/234; F17C 2270/0184; F17C 2203/0626; F17C 2203/0663; F17C 2209/2154; F17C 2270/0168; F17C 2203/0604

(57) ABSTRACT

A pressure vessel for storing fuel is provided. The pressure vessel includes a liner for storing fuel, a fiber-reinforced layer which surrounds the liner at least in regions, and at least one load ring. Connecting pins project from the surface of the load ring, and the connecting pins protrude out of the fiber-reinforced layer. A motor vehicle including such a pressure vessel and a production method for the pressure vessel are also provided.

### CROSS REFERENCE TO RELATED APPLICATIONS

This application is a continuation of PCT International Application No. PCT/EP2016/073877, filed Oct. 6, 2016, which claims priority under 35 U.S.C. § 119 from German Patent Application No. 10 2015 222 392.2, filed Nov. 13, 2015, the entire disclosures of which are herein expressly incorporated by reference.

### BACKGROUND AND SUMMARY OF THE INVENTION

The invention which is disclosed herein relates to a pressure vessel including a load ring, to a motor vehicle including a pressure vessel, and to a method for producing a pressure vessel.

Pressure vessels expand in a manner which is dependent on factors such as the interior pressure p or the temperature T of the pressure vessel. For this reason, pressure vessels are attached to the vehicle body of a motor vehicle in accordance with the locating bearing/floating bearing principle. A construction of this type requires a relatively large amount of installation space. Moreover, it is not capable of transmitting forces and torques from one end of a pressure vessel to another end of the pressure vessel. Said pressure vessels therefore do not contribute or contribute only to a small extent to the rigidity of the vehicle body.

DE 1993551 6 A1 has disclosed a cylinder for pressurized gases having a holding ring flange at the respective ends of the cylinder. Furthermore, DE 10 2010 053874 A1 discloses a holding system for a pressure vessel having two securing caps.

It is an object of the invention which is disclosed herein to reduce or to eliminate the disadvantages of the previously known solutions. In particular, it is an object of the invention which is disclosed herein to provide easier and more compact ways for vehicle integration of a pressure vessel. It is possible, in particular, for this to be a load-bearing pressure vessel. Further objects result from the advantageous effects of the invention which is disclosed herein.

This and other objects are achieved by way of a pressure vessel for storing fuel, a motor vehicle including such a pressure vessel, and/or a method for producing a pressure vessel in accordance with embodiments of the present invention.

The invention which is disclosed herein relates to a pressure vessel for storing fuel for a motor vehicle. A pressure vessel of this type can be, for example, a cryogenic pressure vessel or a high pressure gas vessel.

High pressure gas vessels are configured to store fuel (for example, hydrogen) substantially at ambient temperatures over the long term at a maximum operating pressure (also called MOP) of over approximately 350 bar(g), further preferably of over approximately 500 bar(g) and particularly preferably of over approximately 700 bar(g). High pressure gas vessels are defined, for example, in the standard EN13445. Type III and type IV pressure vessels have, for example, an inner liner made from aluminum and from plastic, respectively, and a fiber-reinforced layer or encapsulation made from fiber-reinforced plastic (FRP). What is known as a type V high pressure gas vessel can advantageously also be provided, that is to say a liner-less pressure vessel.

A cryogenic pressure vessel can store fuel in the liquid or supercritical physical state. A thermodynamic state of a substance, which thermodynamic state is at a higher temperature and at a higher pressure than the critical point, is called a supercritical physical state. A cryogenic pressure vessel is suitable, in particular, to store the fuel at temperatures which lie considerably below the operating temperature (that temperature range of the vehicle environment is meant, in which the vehicle is to be operated) of the motor vehicle, for example at least 50 Kelvin, preferably at least 100 Kelvin or at least 150 Kelvin below the operating temperature of the motor vehicle (usually from approximately −40° C. to approximately +85° C.). The fuel can be, for example, hydrogen which is stored in the cryogenic pressure vessel at temperatures of approximately from 34 K to 360 K.

In order to obtain a pressure vessel with a stress distribution which is as favorable as possible and with regard to the vehicle integration, an elongate pressure vessel with curved (preferably semi-elliptical) pole caps at the two lateral ends (also called domes) is favorable. A pressure vessel of this type can be integrated, for example, centrally in the vehicle tunnel.

The pressure vessel which is disclosed herein for storing fuel in a motor vehicle includes a liner and a fiber-reinforced layer which surrounds the liner at least in regions. Fiber-reinforced plastics (FRP) are used as a fiber-reinforced layer or encapsulation or reinforcement (in the following text, the term “fiber-reinforced layer” is mostly used), for example carbon fiber reinforced plastics (CFRP) and glass fiber reinforced plastics (GFRP). The FRP structure of a pressure vessel has a reinforcing effect as a result of fibers which are embedded in a plastic matrix. An FRP includes fibers and matrix material which have to be combined in a load-oriented manner, in order that the desired mechanical and chemical properties result. The fiber-reinforced layer is usually a layer which has cross-laid plies and circumferential plies. Normally, they handle the entire stresses which result from the interior pressure. In order to compensate for axial stresses, cross-laid plies are wound or woven over the entire liner area. What are known as the circumferential plies which ensure reinforcement in the tangential direction are situated in the cylindrical shell region M. The circumferential plies run in the circumferential direction U of the pressure vessel. The circumferential plies are oriented at a 90° angle with respect to the pressure vessel longitudinal axis A-A.

The technology which is disclosed herein likewise relates to a liner for a pressure vessel for storing fuel. The liner can be produced from a metal, from a metal alloy or from a plastic. For example, a liner made from aluminum or an aluminum alloy is expedient. The fuel is stored in the liner, and the liner is usually responsible for the tightness of the pressure vessel. If, for example, hydrogen is stored, the liner is usually configured to avoid hydrogen permeation. In addition, the liner usually serves as a wound and/or woven core. A metallic embodiment can be designed both in a load-bearing manner and, like a polymer liner, in a non-load-bearing manner. The liner contour is usually selected to be as thin as possible, since the strength of the fiber composite is substantially higher and therefore a thinner overall wall thickness can be achieved. For example, the maximum wall thickness of the liner can be less than 30 mm, preferably less than 10 mm or 5 mm. Just like the pressure vessel, the liner also usually has an elongate shape with curved pole caps. The pole caps and the cylindrical shell region M which is arranged in between are, in particular, advantageously shaped in one piece. An opening is provided in at least one of the pole caps of the liner.

A stub (also called a boss or port) is provided at the opening of the liner. Pressure vessels including a plastic liner usually have a metallic boss. The pressure vessels with a metallic liner normally do not have an additional boss. They have what are known as ports. The boss is usually produced from a steel alloy or aluminum alloy. The boss is advantageously covered at least partially by the fiber-reinforced layer. The boss can serve to connect any fuel lines to the pressure vessel. The boss can have, for example, a neck, to which a fuel line can be flange-connected. To this end, further components can be inserted into the boss, for example by way of an internal thread. At the end which lies opposite the neck, a connecting section of widening configuration can be provided, which connecting section advantageously has the same contour at least in regions as the pole cap of the liner. Said connecting section preferably lies on the liner.

The technology which is disclosed herein includes, furthermore, at least one load ring or load transmission ring or load introduction ring (hereinafter “load ring”) which surrounds the liner at least in regions. In other words, the load ring encloses the outer surface of the liner at least at one point. Here, a load ring is an annular element which is configured to introduce or to transmit forces and/or torques (=loads) into the pressure vessel. The load ring can be produced from a metal, from a plastic or from a metal alloy.

In particular, the load ring can be arranged in the transition regions from the cylinder to the dome of the pressure vessel. Here, the transition region Ü can be the region, in which the liner already has at least 80%, preferably at least 90%, of the mean diameter D₁ which the liner has in the (substantially cylindrical) shell region M. In particular, the transition region can protrude into the shell region M. For example, the transition region Ü can protrude into the shell region M by at most 10% or at most 5% of the entire axial length of the shell region M. The load ring can be arranged immediately laterally adjacently in the axial direction with respect to a circumferential ply region of the fiber-reinforced layer. At least one fiber ply runs in the circumferential direction (hoop ply) in the circumferential ply region of the fiber-reinforced layer. The circumferential ply region is expediently arranged in the shell region M. In particular, the load ring is arranged adjacently with respect to that region of the fiber-reinforced layer, in which the layer thickness of the fiber-reinforced layer is higher on account of the circumferential plies than in the region, in which the load ring is arranged.

The load ring can be configured, for example, as a solid material, for example as an annular plate or clamp. For example, the load ring can have cutouts. The cutouts which are provided in the load ring can advantageously be designed in such a way that a framework structure is produced. Furthermore, it is contemplated that a wire structure (for example, wire mesh) or a lattice structure configures the load ring, from the surface of which the connecting pins or bolts extend away. The framework might also be realized in a different way than by way of stamped-out portions. The framework and/or the wire or lattice structure can be based, for example, on a metallic material and/or on a fiber composite material. Here, the wires, lattices and/or fibers are advantageously oriented in such a way that, in the case of the transmission of forces and/or torques between the connecting pins and the bolts (see below), they act for the most part in accordance with the principle of tension rods or pressure rods. The load ring itself preferably includes at least one laminate layer made from a fiber-reinforced plastic. The fibers of at least one (in particular, unidirectional) ply of the laminate layer are preferably arranged in the circumferential direction (hoop plies). Further plies of the laminate layer can be oriented in a different way. The laminate layer can firstly transmit the forces and/or torques between the connecting pins and bolts, and secondly can also support the fiber-reinforced layer in the pole regions with regard to the forces which result from the vessel interior pressure.

Connecting pins project from the surface of the load ring in a manner which is directed outward. The connecting pins project or protrude out of the fiber-reinforced layer. A load ring can have at least two, preferably at least four connecting pins. In particular, the connecting pins can be configured and arranged in such a way that reinforcing fibers of the fiber-reinforced layer can run between two connecting pins which are adjacent in the circumferential direction. In this way, the load ring and the pole caps can be wound around or woven around simply. Furthermore, the forces and torques which are transmitted by the vehicle body can be introduced into the fiber-reinforced layer in an improved manner. Stress peaks are reduced here. The connecting pins can be fastened to the load ring in an integrally joined manner, for example by way of welding, adhesive bonding, soldering and/or overmolding. The connecting pins and the load ring can further preferably be produced in one piece by way of a primary forming production method. A support reinforcement can be provided at the base of at least one connecting pin (preferably of each load-bearing connecting pin), which support reinforcement can be connected to the load ring in an integrally joined manner. This is preferably a thickened material portion in the region of the connecting pins which configure the transition to the dome cap. The support reinforcements are preferably shaped in such a way that forces which act on the connecting pins can be introduced satisfactorily into the liner and/or into the fiber-reinforced layer. The support reinforcement advantageously widens toward the surface of the load ring. Consequently, the connecting pin therefore has a lower thickness at its free end than at its base which is connected to the load ring. Therefore, stress concentrations in the transition from the connecting pins to the load ring can be reduced. However, the connecting pins particularly preferably do not protrude in the radial direction in relation to the maximum outer circumference of the pressure cylinder. In this way, the required installation space can be restricted further. Furthermore, the risk of undesired and possibly unnoticed damage during the transport of the pressure vessels is reduced.

At least one connecting pin is particularly preferably configured to transmit external loads from a vehicle body of the motor vehicle into the liner and/or into the fiber-reinforced layer of the pressure vessel. To this end, in the installed position of the pressure vessel, at least one part region of at least one connecting pin is preferably coupled directly or indirectly to the vehicle body, with the result that forces can be transmitted. For example, to this end, the connecting pin can have an external thread and/or an internal thread. A fixing mechanism can further preferably be provided for coupling the at least one connecting pin, as disclosed in the German patent application of the applicant with the application number DE 10 2015 206825.0. The disclosures of DE 10 2015 206825.0 which include the fixing mechanism (designations 143, 144; 143′, 144′ therein), its functional arrangement, the interaction with the connecting pin, and the connecting pin itself are herein expressly incorporated by reference. The disclosures of the German patent application of the applicant DE 10 2015 206826.9 which include the fastening apparatus (designations 140, 140′ therein) are likewise herein expressly incorporated by reference.

By way of the invention which is disclosed herein, it is advantageously possible to transmit forces and torques from the vehicle body into the pressure vessel. The overall rigidity of the motor vehicle can therefore be increased significantly in a manner which is inexpensive, approximately weight-neutral and associated with a small installation space requirement.

Furthermore, the technology which is disclosed herein relates to a motor vehicle, in particular a two-track motor vehicle, including a pressure vessel as disclosed herein. The connecting pins of the pressure vessel can advantageously be coupled to vehicle body attaching elements (for example, the abovementioned fixing mechanism) of the motor vehicle in such a way that forces and/or torques can be transmitted from the vehicle body into the pressure vessel. The pressure vessel (in particular, the at least one load ring, the liner and the fiber-reinforced layer) can be configured to transmit forces and/or torques which are greater in terms of the magnitude, for example at least by a factor of 2.5, 4, 8, 10, 20 or 100, than the forces and/or torques which result during operation from the mass of the pressure vessel and the fuel which is contained therein (for example, weight force, transverse acceleration, etc.). In each case one load ring is preferably provided in the two transition regions Ü to the ends of the at least one pressure vessel. In this way, forces can advantageously be introduced at a first end P₁ of the pressure vessel from the vehicle body into the pressure vessel, and can be dissipated at the second end P₂ of the pressure vessel into the vehicle body again. The pressure vessel can therefore be configured as a load-bearing pressure vessel or as a reinforcing element of the vehicle body. The vehicle body can therefore be reinforced without additional struts.

Furthermore, the load ring can include bolts which likewise project to the outside from the surface of the load ring. The bolts preferably do not protrude out of the fiber-reinforced layer. The bolts can serve, in particular, to introduce the forces into the fiber-reinforced layer, which forces were introduced via the connecting pins in the load ring. The bolts are preferably shorter and/or thinner than the connecting pins. In this way, the weight and material costs of the load ring can advantageously be reduced.

The connecting pins and/or the bolts are preferably arranged in such a way that more reinforcing fibers of the fiber-reinforced layer can be laid on the end/ends in the circumferential direction U than in the case of a configuration without connecting pins and/or bolts. In other words, the connecting pins and/or bolts can be configured and arranged in such a way that they act as winding and/or weaving aids, by reinforcing fibers or rovings being supported laterally and therefore being saved from sliding off even in the case, for example, of being deposited in a non-geodetic manner. The connecting pins and/or the bolts are preferably arranged concentrically or substantially concentrically around the opening of the liner.

The bolts and/or the connecting pins are particularly preferably arranged spaced apart from the opening of the pressure vessel. If the bolts and/or connecting pins are arranged in a manner which is spaced apart, forces and/or torques can be introduced into the pressure vessel in a particularly satisfactory manner. The load ring preferably has an internal diameter which corresponds to approximately from 80% to 120% of the mean external diameter of the liner in the shell region M. The load ring preferably has a ring width of from 5 mm to 200 mm, further preferably of from 10 mm to 100 mm, and particularly preferably of from 15 mm to approximately 50 mm. If the load ring has a certain width, the tilting moments are reduced. If the load ring is too wide, however, the weight is increased and assembly is made more difficult. The load ring itself (without bolts and/or connecting pins) preferably has a thickness of from 0.1 mm to 10 mm, further preferably of from 0.25 mm to 5 mm, and particularly preferably of from 0.5 mm to approximately 2 mm.

The load ring can be arranged, in particular, in a cut-out region of the liner, for example in a groove or in an annular seat. The groove and the load ring can be configured in such a way that the surface of the load ring terminates flush with the surface of the liner. In this way, stress peaks in the fiber-reinforced layer can advantageously be reduced.

In addition to a circular cross-sectional geometry, the connecting pins and/or bolts can also have different cross-sectional geometries (for example, oval or elongate cross-sectional geometries). They are configured and arranged, in particular, in such a way that fibers of the fiber-reinforced layer can run between adjacent bolts and connecting pins.

The load ring can be configured, in particular, in one piece with a boss or port of the pressure vessel.

The load ring can lie directly or indirectly on the liner and/or possibly on the boss or port at least in regions. In this context, “indirect” means that at least one intermediate layer can be arranged between the load ring and the liner and/or possibly boss or port. Said intermediate layer can serve, for example, to prevent contact corrosion between two metal materials. An intermediate layer can also serve to fix the load ring during the weaving and/or winding process. A fiber-reinforced layer might likewise be used as an intermediate layer. The load ring can therefore also be attached to some layers of fiber material of the fiber-reinforced layer. It does not necessarily have to lie on the liner. For example, a pair of plies of the fiber-reinforced layer might first of all be applied, then the load ring might be positioned onto said plies, before subsequently further plies of the fiber-reinforced layer are deposited.

Furthermore, the invention which is disclosed herein also relates to a method for producing a pressure vessel. The method includes the acts of:
providing a liner for storing fuel;
providing at least one load ring, the load ring and the liner being configured as disclosed herein; and
applying a fiber-reinforced layer, the fiber-reinforced layer covering the load ring at least partially, and the connecting pins of the load ring projecting out of the fiber-reinforced layer.

The fiber-reinforced layer or encapsulation is usually produced in a winding process and/or in a weaving process. The thickness of the fiber-reinforced layer is preferably lower at least in regions than the length of at least two connecting pins, with the result that, in the installed position of the pressure tank, the connecting pins can be coupled directly or indirectly to the vehicle body.

The invention which is disclosed herein also relates to a component for introducing mechanical loads into the fiber composite material reinforcement of a pressure vessel, in particular in the transition region between the cylinder and the dome. The pressure vessel includes an annular crown (e.g., load ring or ring) with connecting pins which are arranged to the outside parallel to the radius and penetrate the laminate from the inside to the outside over its entire thickness. Mechanical load can be introduced from the outside into the pressure vessel using the connecting pins. The connecting pins are expediently made from solid material, the length of which protrudes beyond the surface of the laminate, possibly with a thread. Therefore, the introduction of tensile, compressive and torsional loads can take place via a positively locking and screwed attachment. In addition to the connecting pins, further shorter and thinner bolts can be attached on the ring in a similar arrangement as the connecting pins for the introduction of force. The further bolts introduce the load into the CFRP reinforcement in a manner which is distributed uniformly over the entire circumference of the ring, and therefore reduce the stress peaks at the load introduction points. Excessively high stress peaks can lead to damage of the material. The load ring can be manufactured from a metallic material, a fiber composite material or another suitable material. The load ring can be designed in such a way that it also absorbs circumferential and flexural stresses which are caused by the interior pressure, and therefore smoothes the characteristic stress peaks in said region. The connecting pins can be designed in a neutral manner in terms of installation space and/or diameter by being positioned next to the end of the circumferential plies of the CFRP reinforcement. In addition, it is contemplated that the load ring is sunk into a groove in the liner, in order to make a step-less transition between the liner and the load ring and a smaller diameter possible.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a cross-sectional view of a pressure vessel.

FIG. 2 is an enlarged cross-sectional view of the detail A in accordance with FIG. 1.

FIG. 3 is a further enlarged cross-sectional view of the detail A in accordance with FIG. 1.

FIG. 4 is a further enlarged cross-sectional view of the detail A in accordance with FIG. 1.

FIG. 5 is a sectional view along the line B-B of FIG. 2.

### DETAILED DESCRIPTION OF THE DRAWINGS

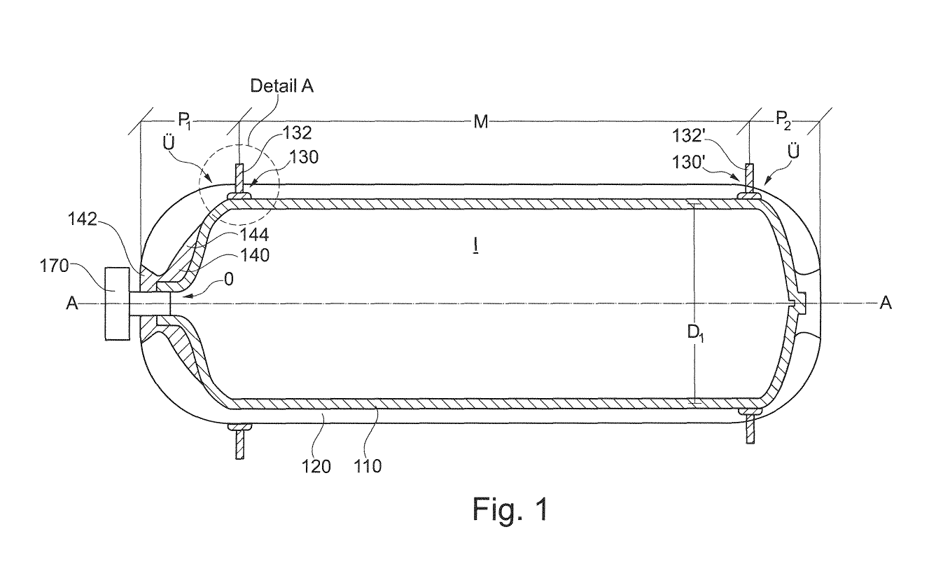

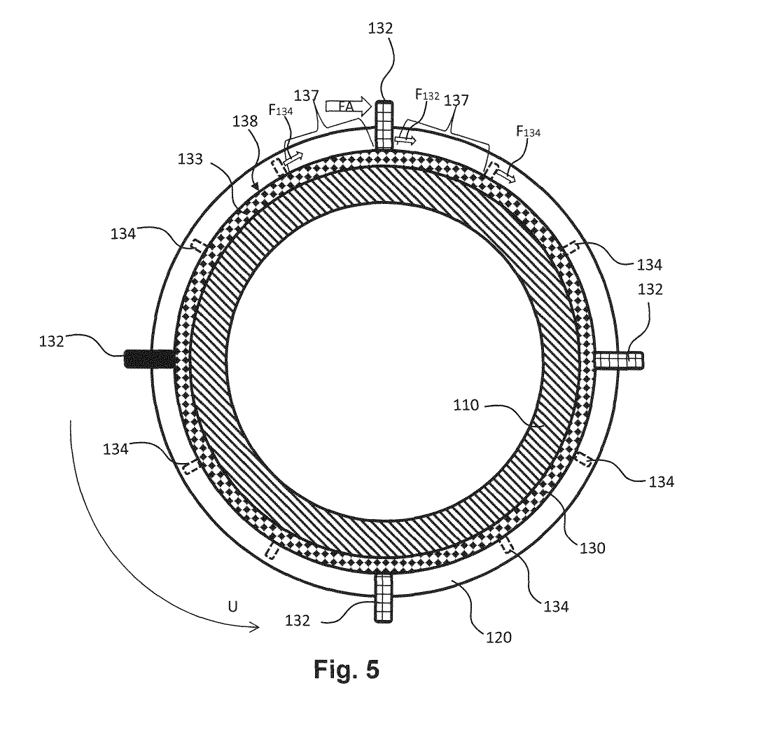

FIG. 1 shows a partial cross-section of a pressure vessel with a liner 110 and a fiber-reinforced layer 120. The liner 110 configures a storage volume 1 for the fuel. An outlet or an opening O for the stored fuel is provided at the front end P₁. Said opening O and the boss 140 are not to be considered to be a connecting pin 132. The connecting pins 132 project from the surface 138 (cf. FIG. 5) of the load ring 130. The connecting pins 132 can have a support reinforcement (not shown) at the base of the connecting pins 132. Here, the connecting pins 132 are configured in one piece with the load ring 130 which bears directly against the liner 110 here. Here, the load ring 130 protrudes into the shell region M of the pressure vessel or the liner 110. Here, the load ring 130 is covered completely by the fiber-reinforced layer 120. Merely the connecting pins 132 protrude out of the fiber-reinforced layer 120. The protruding part of the connecting pins 132 advantageously serves to couple the pressure vessel to the vehicle body. The boss 140 has a neck 142, in which a further connector element 170 is inserted here. Adjacently with respect to the connecting pins 132, bolts 134 can likewise be arranged spaced apart radially from the boss (not shown here; cf. FIG. 5). If forces and torques are then transmitted by the vehicle body (not shown) to the connecting pins 132, said forces and torques are partially introduced directly into the fiber-reinforced layer 120. The load ring section 137 (not shown here; cf. FIG. 5) between the respective connecting pins 132 and bolts 134 can also transmit said forces and torques at least partially to the bolts 134. The bolts 134 then introduce the forces and/or torques into the fiber-reinforced layer 120 in a non-positive manner. Furthermore, the load ring section 137 introduces a part of the forces and torques into the fiber-reinforced layer 120 in an integrally joined manner. The forces and torques which are transmitted by the vehicle body are therefore introduced partially by way of the connecting pins 132 and bolts 134, in each case in a positively locking manner, and by way of the surface of the load ring section 137, in an integrally joined manner, into the fiber-reinforced layer 120. The forces and torques are therefore introduced comparatively extensively into the fiber-reinforced layer 120. Punctiform loads are reduced. Comparatively high forces and torques can therefore be transmitted overall with a low pressure vessel weight at the same time. Furthermore, the construction which is disclosed herein can be produced comparatively simply and therefore inexpensively. The load ring 130 itself additionally reinforces the vessel with regard to forces which result from the vessel interior pressure. If, for example, a load ring 130 made from a fiber-reinforced plastic is used, the fibers in the laminate can advantageously be arranged in the circumferential direction U (cf. FIG. 5). A blind boss is provided at the second end P₂. Here, the load ring 130′ bears predominantly against the liner 110. Otherwise, the load ring 130′ corresponds substantially to the load ring 130. Here, the load rings 130, 130′ can also be produced, for example, from aluminum or an aluminum alloy.

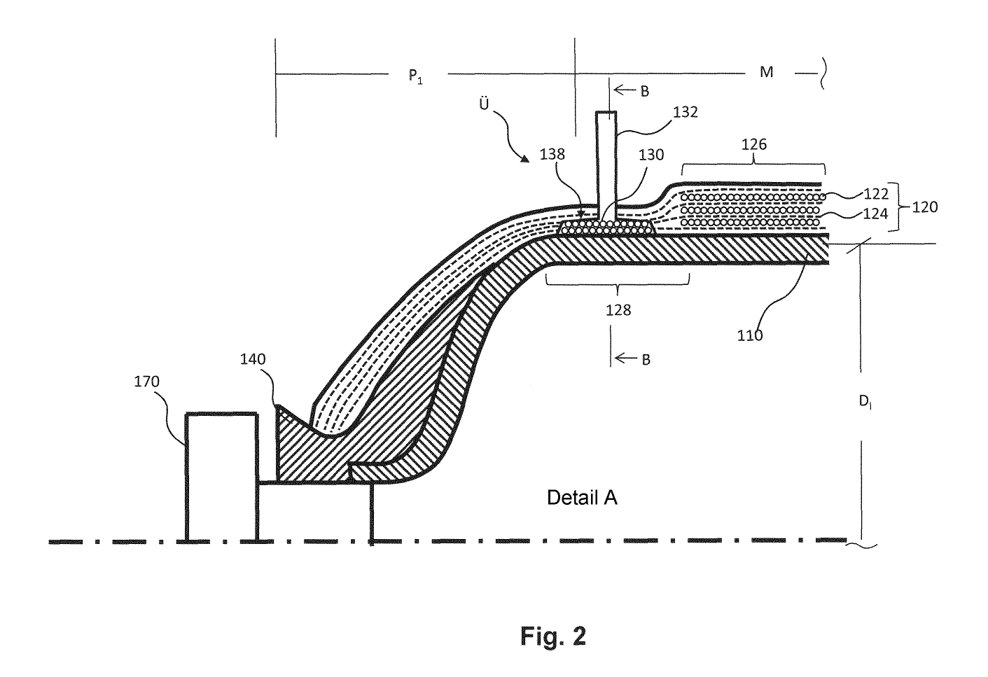

FIG. 2 shows the detail A from FIG. 1. Circumferential plies (=hoop layers) 122 are provided in the circumferential ply region 126 in the fiber-reinforced layer 120, in the shell region M, which circumferential plies 122 run in the circumferential direction U, that is to say perpendicularly out of the plane of the drawing (that is to say, perpendicularly with respect to the axial and radial direction). On account of the additional circumferential plies 122, the circumferential ply region 126 has a greater thickness than an adjacent fiber region 128. The adjacent fiber region 128 is arranged directly next to the circumferential ply region 126 in the axial direction of the pressure vessel, and so as to adjoin said circumferential ply region 126. Here, said transition from the circumferential ply region 126 to the adjacent fiber region 128 makes up the transition region Ü. The load ring 130 includes a plurality of connecting pins 132, of which only one is shown here. The connecting pins 132 project perpendicularly to the outside from the surface 138 of the load ring 130. Furthermore, the load ring 130 has bolts 134 which are arranged offset in the circumferential direction here (not shown here; cf. FIG. 5). The load ring 130 itself has at least one laminate layer 133, the fibers of which run in the circumferential direction U. Therefore, the load ring 130 is capable, in a similar manner to the circumferential plies 122 in the circumferential ply region 126, of absorbing forces which are caused by the pressure vessel interior pressure.

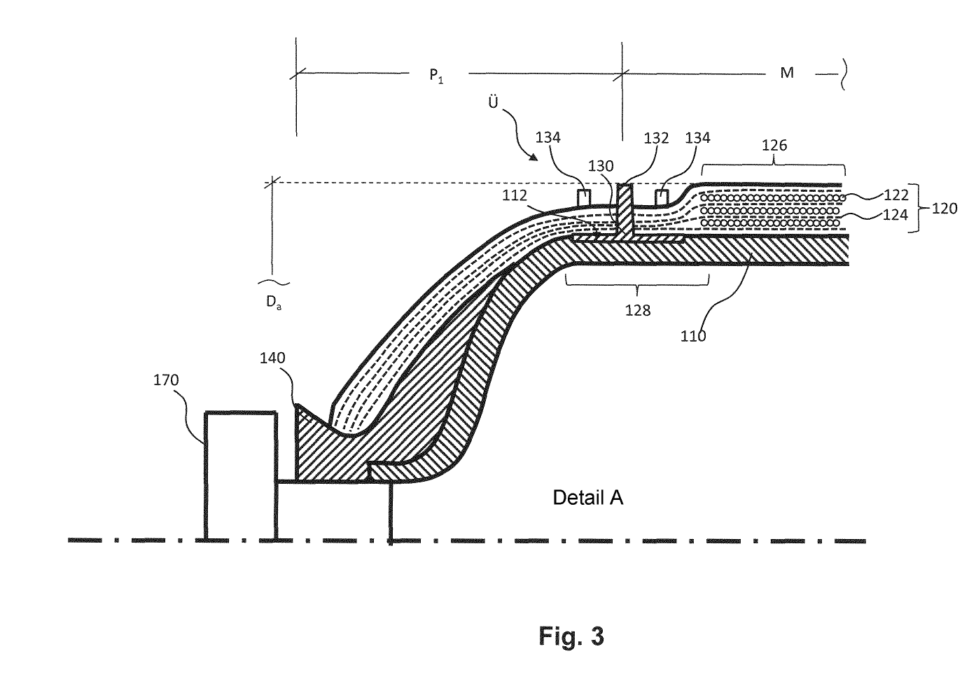

FIG. 3 shows a further refinement of the detail A. In the following text, only the differences in comparison with the embodiment in accordance with FIG. 2 will be described. All other features are substantially identical. The pressure vessel which is shown here has a load ring 130 which is embedded in a cut-out region 112 (an annular groove here). Here, the surface 138 (cf. FIG. 5) of the load ring is configured so as to be flush with the adjacent surfaces of the liner 110. Furthermore, the connecting pins 132 and the bolts 134 do not protrude beyond the external diameter Dₐ of the pressure vessel. Here, the bolts 134 and the connecting pins 132 are arranged offset in the axial direction with respect to one another. Here, furthermore, two rows of bolts are shown which, moreover, protrude out of the fiber-reinforced layer; these do not both have to be the case, however. Here, the load ring is of wider configuration than in the refinement in accordance with FIG. 2. Here, the load ring 130 is formed from an aluminum sheet. Other materials can likewise be used, however. 100% of the bolts can be concealed in the fiber-reinforced layer 120. The connecting pins 132 expediently project out of the fiber-reinforced layer, in order to make a connection to the vehicle body possible.

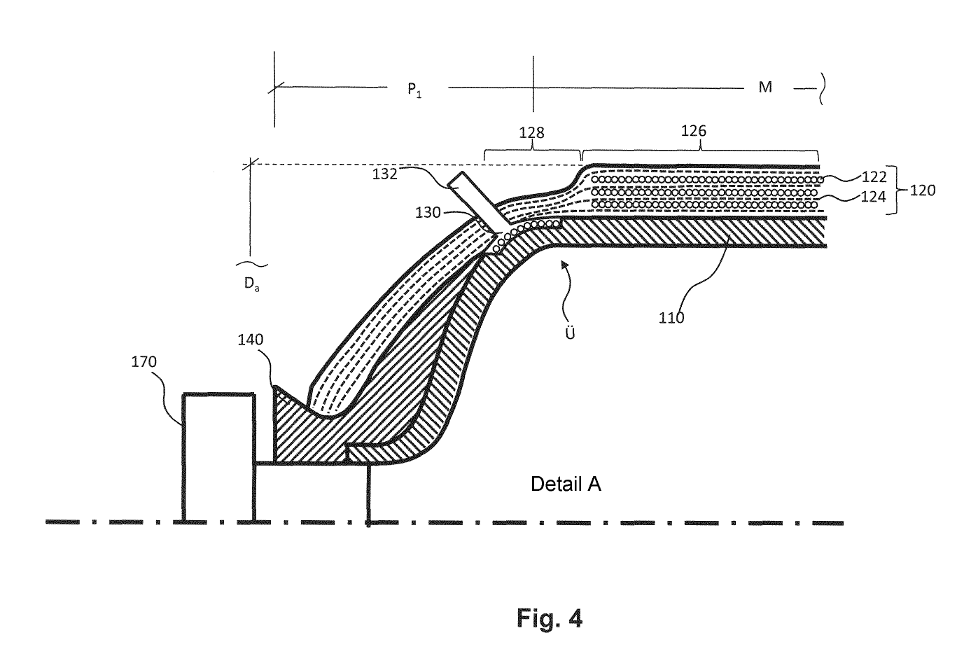

FIG. 4 shows a further refinement of the detail A. In the following text, only the differences in comparison with the embodiments in accordance with FIGS. 2 and 3 will be described. Here, the load ring 130 is not arranged completely in the shell region M, but rather likewise extends into the pole cap P₁. In the pole cap region, in particular, it is difficult to deposit reinforcing fibers in the circumferential direction U. The load ring 130 can be manufactured separately. It can be easier to provide circumferential plies in the load ring 130, which circumferential plies then avoid stress peaks in the installed position in the pressure tank. The supporting face of the load ring 130 is shaped in a corresponding manner with respect to an annular seat of the liner 110. In particular, the supporting face and the annular seat are designed in such a way that the load ring 130 can be pushed onto the annular seat laterally from one end of the liner. The load ring can therefore be mounted and/or positioned easily before the application of the fiber-reinforced layer 120. The surface 138 of the load ring 130 terminates flush with the adjacent surface sections of the liner 110.

FIG. 5 shows a sectional view along the line B-B from FIG. 2. Here, the pressure tank is configured with a circular cross section. Here, the load ring 130 lies directly on the liner 110. Here, connecting pins 132 and bolts 134 project in the radial direction from the surface 138 of the load ring 130. Here, the adjacent bolts 134 and connecting pins 132 are arranged in each case spaced apart in the circumferential direction from one another. If a force FA or a torque is then received via a connecting pin 132, the connecting pin 132 transmits a part of said load directly to the fiber-reinforced layer 120 (arrow F132). The other part of said load is introduced into the load ring 130. The load ring 130 or the load ring sections 137 transmits/transmit said other part to the bolts 134 which in turn distribute the load into the fiber-reinforced layer 120. The integrally joined introduction of load from the load ring section 137 into the fiber-reinforced layer 120 on the surface 138 of the respective load ring section 137 is not shown in further detail. The load ring can likewise also be attached to some fiber plies. It does not necessarily have to be fixed on the liner.

FIGS. 1 to 5 show an elongate pressure vessel which has a cylindrical region M and correspondingly curved ends P₁, P₂. Other pressure vessel shapes are also contemplated, however, and are also included by the technology which is disclosed herein. For example, the pressure vessel can have an elliptical basic shape. The cylindrical region M can also be of more bulbous configuration. The diameter might then vary in the cylindrical region M. The pressure vessel might also not be of rotationally symmetrical configuration.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

List of Designations

| | |
|---|---|
| Liner | 110 |
| Groove | 112 |
| Fiber-reinforced layer | 120 |
| Circumferential plies | 122 |
| Circumferential ply region | 126 |
| Adjacent fiber region | 128 |
| Load ring | 130 |
| Connecting pins | 132 |
| Laminate layer | 133 |
| Bolt | 134 |
| Cap opening | 136 |
| Load ring section | 137 |
| Surface | 138 |
| Boss | 140 |
| Neck | 142 |
| Connecting section | 144 |
| Connector element | 170 |
| Opening | O |
| Pressure vessel longitudinal axis | A-A |
| Circumferential direction | U |
| Shell region | M |
| End, pole cap region | P1, P2 |
| Transition region | U |
| Liner diameter | D1 |

What is claimed is:

1. A pressure vessel for storing fuel, comprising:
a liner for storing fuel;
a fiber-reinforced layer which surrounds the liner at least in regions; and
at least one load ring which encloses the liner, wherein
connecting pins project from a surface of the load ring, and
the connecting pins protrude out of the fiber-reinforced layer.

2. The pressure vessel according to claim 1, wherein the load ring comprises bolts which project from the surface of the load ring.

3. The pressure vessel according to claim 1, wherein
the load ring comprises at least one laminate layer, and
fibers of at least one ply of the laminate layer is oriented in a circumferential direction.

4. The pressure vessel according to claim 2, wherein
the load ring comprises at least one laminate layer, and
fibers of at least one ply of the laminate layer is oriented in a circumferential direction.

5. The pressure vessel according to claim 1, wherein
the load ring bears directly or indirectly at least in regions against a boss and/or against a port, and/or
the load ring is configured in one piece with the boss and/or the port of the pressure vessel.

6. The pressure vessel according to claim 4, wherein
the load ring bears directly or indirectly at least in regions against a boss and/or against a port, and/or
the load ring is configured in one piece with the boss and/or the port of the pressure vessel.

7. The pressure vessel according to claim 1, wherein the load ring is arranged in a cut-out region of the liner.

8. The pressure vessel according to claim 6, wherein the load ring is arranged in a cut-out region of the liner.

9. The pressure vessel according to claim 7, wherein the cut-out region is a groove or an annular seat.

10. The pressure vessel according to claim 8, wherein the cut-out region is a groove or an annular seat.

11. The pressure vessel according to claim 9, wherein
the load ring and the supporting face and/or the annular seat are/is designed in such a way that the load ring is pushable on laterally from one end of the liner.

12. The pressure vessel according to claim 10, wherein
the load ring and the supporting face and/or the annular seat are/is designed in such a way that the load ring is pushable on laterally from one end of the liner.

13. The pressure vessel according to claim 1, wherein
the load ring is arranged in a transition region of the pressure vessel, and
the load ring extends into a region of a pole cap.

14. The pressure vessel according to claim 12, wherein
the load ring is arranged in a transition region of the pressure vessel, and
the load ring extends into a region of a pole cap.

15. The pressure vessel according to claim 1, wherein
the load ring is arranged adjacently in an axial direction with respect to a circumferential ply region of the fiber-reinforced layer, in which at least one fiber ply runs in a circumferential direction.

16. The pressure vessel according to claim 14, wherein
the load ring is arranged adjacently in an axial direction with respect to a circumferential ply region of the fiber-reinforced layer, in which at least one fiber ply runs in the circumferential direction.

17. A motor vehicle, comprising:
at least one pressure vessel according to claim 1, wherein
the connecting pins of the pressure vessel are coupled to vehicle body attaching elements of the motor vehicle in such a way that forces and/or torques are transmittable from a vehicle body into the pressure vessel.

18. The motor vehicle according to claim 17, wherein two load rings are provided on the at least one pressure vessel.

19. A method for producing a pressure vessel, the method comprising the acts of:
providing a liner for storing fuel;
providing at least one load ring and configuring the load ring to enclose the liner; and
applying a fiber-reinforced layer such that the fiber-reinforced layer covers the load ring at least partially, and connects pins of the load ring protruding out of the fiber-reinforced layer.
